(19) United States
(12) Patent Application Publication
(10) Pub. No.: US 2009/0014367 A1
(43) Pub. Date: Jan. 15, 2009

(54) Floating materials removal system

(76) Inventor: Norikata Takuma, Tokyo (JP)

Correspondence Address: SHLESINGER, ARKWRIGHT & GARVEY LLP, Suite 600, 1420 King Street, Alexandria, VA, 22314, US

(21) Appl. No.: 12/000,473

(22) Filed: Dec. 13, 2007

(30) Foreign Application Priority Data
Jul. 10, 2007 (JP) 2007-180494

(51) Int. Cl. C02F 1/00

(52) U.S. Cl. 210/109; 210/170.11; 210/143

(57) ABSTRACT

New floating materials removal system, which can catch floating materials such as big jellyfishes, wood chips, waste plastics and other things floating instantly, release the floating materials caught efficiently and discharge them to discharge line smoothly, is proposed. The system in this invention is characterized to have the following equipments, the main rotating removal screen which catches the floating materials such as big jellyfishes, wood chips, waste plastics and other things floating in water by endless rotation and has kind of nets to send the floating materials caught to the position higher than water surface, the receiving tray which receives the floating materials caught by the main rotating removal screen and sends them to discharge line, the secondary lifting devise which cooperates with above mentioned main rotating removal screen to lift and transfer the floating materials caught to the receiving tray, the water jet system which drops the floating materials caught, that are lifted higher than the receiving tray because hooked on the rotating removal screen and not released from it, to the receiving tray, and the cutting water jet system of floating materials caught which is attached to the receiving tray.

### FIELD OF THE INVENTION

This invention relates to the floating materials removal system, which removes the floating materials such as big jellyfishes, wood chips, waste plastics and other things floating in the neighborhood of the intake of cooling water in power plants or factories.

### BACKGROUND OF THE INVENTION

In the power plant using seawater as cooling water, for example, returning warm water to the sea grows jellyfishes and they block water intake. In such case smooth water intake cannot be attained. In order to solve this problem various systems were proposed in the past as indicated below. However these systems were not good enough to solve the problem. Recently appearance of very big ECHIZEN jellyfishes (scientific name is Stomolopus-Nomurai) which have more than two meters diameter umbrella and more than 150 Kg weight become not only nuisance for fishermen but also problem for power plant and other plants.

Various systems now employed are as follows.

Power plant which lowers the temperature of returning seawater and prevents the grow of jellyfishes (Patent reference No. 1).

System, which has reverse jet stream to the sea direction that flows out jellyfishes caught by the screen installed in the intake of seawater and prevents the inflow of jellyfishes (Patent reference No. 2).

Jellyfish ground system, which grinds jellyfishes in the seawater and solid portion of this ground material is flocculated and settled by chemicals, and separated waste water is returned to public water line (Patent reference No. 3).

Jellyfish inflow preventing system, which has curtain wall and this curtain wall and the wall side flow produced by this curtain wall collects jellyfishes in the so-called jellyfish remaining area (Patent reference No. 4).

Jellyfish inflow preventing system, which has moving curtain that secures enough open space for water intake (Patent reference No. 5).

Seawater intake system, which detects jellyfish, other living things and waste, and transfers these things to the big capacity removing vessel continuously and automatically (Patent reference No. 6).

Patent reference No. 1: Japanese Patent Publication Heisei 08-338204
Patent reference No. 2: Japanese Patent Publication Heisei 10-245834
Patent reference No. 3: Japanese Patent Publication 2004-255313
Patent reference No. 4: Japanese Patent Publication 2004-278144
Patent reference No. 5: Japanese Patent Publication 2004-225482
Patent reference No. 6: Japanese Patent Publication 2004-232379

After analyzing the above examples the following conclusions are obtained.

In order to remove the disturbing floating materials efficiently, two actions below have to be cooperated smoothly.

(1) Catching the floating materials instantly.
(2) Releasing the floating materials caught efficiently and transferring them to water discharge line smoothly.

In the case only (1) is emphasized and (2) is not considered sufficiently, untreated floating materials accumulates in the system and the whole system might be stopped when volume of the floating materials becomes larger than certain limit. Consequently the system has to satisfy (1) and (2) simultaneously.

The previous technologies were searched particularly regarding to the main rotating removal screen which collects floating materials by endless rotating and the floating materials caught are conveyed to the higher position than water surface. Detail of this system is mentioned lately. No previous technology was found in this category.

### DISCLOSURE OF THIS INVENTION

### Issue to be Solved by this Invention

The objective of this invention is to provide the new floating materials removal system which catches the floating materials instantly and releases the floating materials caught efficiently and the receiving tray, which receives the floating materials caught, can cut the floating materials such as jellyfishes smaller and transfer them to the discharge line.

### Measure to Solve the Issue

In order to accomplish the objective above, the floating materials removal system in this invention is characteristic in having the main rotating removal screen which catches the floating materials such as big jellyfishes and transfers the floating materials caught to higher position than water surface by endless rotation, and the receiving tray which receives the floating materials caught by this main rotating removal screen above and transfers them to the discharge line.

Furthermore, it is possible to add the secondary lifting devise which cooperates with main removal rotating screen mentioned above to transfer floating materials caught to the receiving tray, or to add the water jet system to drop down the floating materials caught but be hooked to the rotating removal screen, not to be released from it and be lifted to higher position than the receiving tray, or to add the cutting water jet system on the receiving tray to cut the floating materials caught smaller.

The cutting water jet system mentioned above is provided to have the control system to jet and stop cutting water jet. Jetting surface for cutting water can be divided to several numbers of areas, and the cutting water control system can be designed to control jet and stop according to the control unit which may be one or several of the above mentioned areas.

Furthermore, above mentioned control system should be comprised with the sensor to detect the existence of the floating materials caught, the electromagnetic valve installed in the cutting jet water supply line and the control circuit to open the above mentioned electromagnetic valve electrically based on the signal of the above mentioned sensor and to close the above mentioned electromagnetic valve by the predetermined time interval or by the disappearance of the detecting object of the above mentioned sensor.

### EFFECT OF THIS INVENTION

The floating materials removal system in this invention has the main rotating removal screen which catches the floating materials in the water and simultaneously transfer the floating materials caught to the higher position than water surface by endless rotation, and the receiving tray which receives the floating materials caught by the main rotating removal screen and sends them to the discharge line.

Consequently in the case water drawing line and water intake line are installed as L shape like FIG. 1, seawater in the water drawing line flows into the main removal rotating screen through the side surface and lead to the water intake line through the eyes (holes) existing in the wall surface of the screen, and the floating materials in seawater are hooked and caught to the inside wall surface of the main rotating removal screen by the water pressure of the flowing water and the floating materials caught are conveyed to a higher position than water surface by the rotation of the main rotating removal screen and transferred to the discharge line through the receiving tray.

Therefore removal of the floating materials is accomplished effectively. Particularly the blockage of the screen by the hooked floating materials does not occur and water feed to water intake line is always maintained and stable water supply to the power plants and factories can be accomplished.

Furthermore, since the secondary lifting devise is installed which lifts and transfers the floating materials caught to the receiving tray together with the main rotating removal screen, the floating materials caught by the main rotating removal screen are securely lifted to the height of the receiving tray and transferred to the receiving tray effectively.

Since water jet system is installed to force to drop the floating materials caught by the rotating removal screen but hooked to the screen and not to fall to the receiving tray, the floating materials caught can be effectively transferred to the receiving tray.

Since the receiving tray has the cutting water jet system to cut the floating materials caught smaller, removal of the floating materials caught such as big jellyfishes can be performed effectively and easily.

This cutting water jet system is designed to have control system to control jet and stop the cutting water, and jet surface of cutting water is divided to several areas and control system to jet and stop the cutting water depending on the one or plural control unit as divided above.

For example, if this control system has the sensor to detect the existence of the floating materials caught, the electromagnetic valve on the supply line of cutting water to the cutting water jet system, and the control circuit to open the electromagnetic valve based on the detecting signal of the above mentioned sensor and to shut the above mentioned valve by the predetermined time interval or by the disappearance of detecting object of the above mentioned sensor, it is possible to jet high pressure water only when above mentioned sensor detects the floating materials caught and only from the cutting water jet panel in the designated area, and therefore water jet to unnecessary area can be avoided, and the operation can be done effectively and economically.

### THE BEST STRUCTURE TO PERFORM THIS INVENTION

The example of the floating materials removal system based on this invention is explained in FIG. 1 through FIG. 3. FIG. 1 is flat view to show the whole concept. FIG. 2 is side view of the same and FIG. 3 is the conceptual figure to show the main part of receiving tray.

This floating materials removal system is provided by the short tube type main rotating removal screen 2 which catches the floating materials 3a in water by endless rotating motion, and conveys the floating materials caught 3b to higher position than water surface by the endless rotating motion operated by the operation board 1, the receiving tray 5 which receives the floating materials caught 3b by the above mentioned main rotating removal screen 2 and transfers it to the discharge line, and the secondary lifting devise 6 which lifts and places the floating material caught 3b on the receiving tray 5 together with the above mentioned main rotating removal screen 2. The secondary lifting devise 6 is designed to operate endlessly and continuously in the same speed and direction of the main rotating removal screen.

Above mentioned floating materials removal system is installed in the L shaped intersection of water drawing line 7, which draws seawater from the sea as cooling water, and water intake line 8 to power plant (factory). Consequently seawater of the water drawing line 7 is fed to the main rotating removal screen 2 from the side surface and led to the water intake line 8 through the eyes (holes) of the wall surface of the screen 2.

The floating materials 3a in the seawater is hooked and caught to the inside wall of the main rotating removal screen by the water pressure of the flowing water, then the floating material caught 3b is conveyed to the higher position than water surface by the rotation of the main rotating removal screen 2.

When transferring the materials to the higher position than water surface by the main rotating removal screen 2 only, the following problems may be seen frequently.

Among the floating materials caught 3b by the main rotating removal screen 2, there are lots of materials caught with the weak force and they can be separated by the small wave on the water surface or the contact with the air and they may coagulate and adhere to the wall surface of the main rotating removal screen 2 and some of them may remain and float on the water surface. When the volume of these remaining and floating materials become large, floating materials caught 3b by the main rotating removal screen 2 with strong force can be scraped down, which is not desirable and when the situation goes worse, the system may become non-operational.

Therefore in the floating material removal system in this example, above mentioned serious problem is to be solved by the introduction of the secondary lifting devise 6.

The floating materials removal system in this example has the secondary lifting devise 6 which rotates in the same direction and same speed as the main rotating removal screen 2 and this devise is installed against the main rotating removal screen 2 as shown in the figure. In cooperation of the secondary lifting machine 6 and the main rotating removal screen 2, above mentioned accumulated and floated floating materials caught 3b and the floating materials 3c in the adjacent water surface can be clipped up from both sides and transferred to the receiving tray 5.

Above mentioned rotating removal screen 2 can be anything which permits the passage of seawater but catches the floating materials 3a in that seawater. For example mesh belt composite, composite of net whose edge is adhered to non edge material, caterpillar type endless composite made by the combination of required number of small frame covered by net, or small frame covered by the board which has round holes or long circular holes, or small frame covered by lots of rods or other composites can be utilized.

Above mentioned receiving tray 5 is maintained as sloped position over the water surface by supporting stand (not shown in the Figure) and moves the floating materials caught 3b, which receives from the co-work of above mentioned rotating removal screen 2 and secondary lifting devise 6, to the discharge line 4 by the above mentioned slope. This receiving tray 5 can be positioned correctly by buoyancy.

Furthermore above mentioned rotating removal screen 2 is designed as that the part of it 2b, moving to the water surface from the water bottom, has the slope declined to the downstream direction, so that floating materials 3a in the water can be easily aggregated in the neighborhood of the water surface. By this measure, above mentioned lifting function is kept in the better condition.

On the upper portion 2a of the above mentioned rotating removal screen 2, water jet system is installed to make it easy to drop floating materials caught 3b to the receiving tray 5 in the case when the floating materials caught 3b are hooked and not released from the rotating removal screen 2 and brought to the higher position than receiving tray 5. By the water pressure floating materials caught 3b are released and dropped from the rotating removal screen 2.

The floating materials removal system mentioned in the above practice basically employs the measure to flow down the floating materials caught 3b moved on the receiving tray 5 utilizing the slope of the receiving tray 5. However it is anticipated that this mechanism only may not function enough for the big jellyfishes such as ECHIZEN jellyfishes, which are recently become the problem. Therefore, additional structure indicated below can be taken.

For example lots of small holes 10 whose diameter is 1 mm are placed 10 cm interval in the x and y directions, and high pressure (for example about 30 atm.) water is jet from these small holes 10. Jet water direction is set angled downstream direction as shown in FIG. 3. Small holes 10 can be not only circles but also slit type, and the interval between holes can be shorter or longer than 10 cm.

Floating materials caught 3b, which is jellyfishes, are cut down to, for example, 10 cm length, by the strong thin water flow from downstairs, and jellyfishes cut are easily flown to the downstream direction by the angled thin jet force. In other words by the means of high pressure jet stream to desired direction through small holes, two things, cut down big jellyfishes to smaller pieces and flow down to the next handling direction, are performed simultaneously.

Consequently it can be avoided to have the situation, where even though big jellyfishes are lifted on the receiving tray 5, they are aggregated there and cannot be handled.

Regarding the cutting water jet system which cuts down jellyfishes by the high pressure jet water through above mentioned small holes 10, it is possible to operate it and to give jet water throughout the main rotating removal screen 2 is rotated and sends the floating materials caught 3b to the receiving tray 5. However considering the purpose of this jet stream, it is reasonable and effective to control to give jet stream only when floating materials caught 3b, which should be cut, exist on the receiving tray 5, and only on the portions where floating materials caught 3b exist.

FIG. 4 shows a example of this control schematically and this sort of control is easily realized by installing the electromagnetic valve 40 in the cutting water supply line to the small holes 10 of the cutting water jet system, and the simple sensor 30 to detect the floating materials caught such as jellyfishes on the surface of the receiving tray 5, and by comprising to open and shut the electromagnetic valve according to the detecting signal of the sensor 30.

For example in the case of using reflecting type sensor as the sensor 30, the efficient control measure for the cutting jet water system is secured by the sensor 30 whose emitting or signaling surface are installed upright on the receiving tray 5 and the control circuit 50 which opens the electromagnetic valve 40 electrically by the detecting signal of the sensor 30 and shuts the electromagnetic valve 40 according to the predetermined setting.

In the above mentioned control example of using reflecting type sensor, when the floating materials caught are located over the sensor 30, then the detecting signal of sensor 30 is sent to the control circuit 50 through the sensor cable 23, and it makes the relay switch ‘on’ condition. So it opens the electromagnetic valve 40 which is connected to the control circuit 50 through the electric cable 41 and shuts the electromagnetic valve 40 by the elapse of predetermined time period or by the disappearance of the detecting object. Therefore the cutting water jet is given only when the floating material is located over the sensor 30 and cutting is done effectively if the floating material is jellyfish.

On the above control example, the reflective type sensor is used as the sensor 30, however the type of sensor is not limited to a certain type but any type can be used if it can detect the floating materials caught. For example in the case passage type sensor (can be called blockage type sensor) is used, a couple of sensor setting positions 5a are installed on the receiving tray 5 not to interfere the flow down of the floating materials caught, and emitting or signaling unit and receiving unit for emission or signal are installed on the opposite position of the sensor setting positions 5a. It is good enough to design that the detecting signal is sent from the sensor 30 to the control circuit 50, when the floating materials caught are located between these two units. (FIG. 4(b))

Of course it is not necessary to have one to one match among the numbers of small holes 10 to jet cutting water, sensor 30 for control and electromagnetic valve 40 to control the jet of cutting water. Jet surface of cutting water jet system which has small holes 10 for jet water is divided to appropriate number of areas, and sensor 30 and electromagnetic valve 40 are installed to each divided area, in other words, each control unit. Then it is possible to control to jet cutting water only when the floating materials caught exist on the jet surface and only in the area where floating materials caught exist.

FIGS. 5 and 6 show example of control where jet surface of the cutting water jet system is divided to a desired number of areas, and one divided area corresponds to one control unit. On this example shown in the figures, the cutting water jet panel 21 and the sensor block 31 are combined and installed as jetting surface, and a sheet of cutting water jet panel 21 which has small holes to jet cutting water is regarded as a smallest control unit.

The cutting water jet panel 21 shown in this example is a box type structure which has inner space where water receiving part 22 is installed. The surface of this panel is holed a desired number of small holes which is connected to the water receiving part 22. As shown in FIG. 5 this panel is designed to receive high pressure cutting water through water supply branch pipe 23 connected to the water receiving part 22 and to jet high pressure water through small holes 10. The water supply branch pipe 23 has electromagnetic valve 40 installed.

The sensor block 31 is a thin box type structure and sensor 30 (reflective type sensor) is installed on the upper surface of this block and the sensor 30 is connected to sensor cable 32. In this example shown in FIG. 5, height and width of this sensor block are designed to be equal to those of cutting water jet panel 21.

In this cutting water jet system shown in the example figures, it is possible to construct a desired area of jet surface by combining appropriate number of cutting water jet panels 21 and sensor blocks 31. In FIG. 6, four sheets of cutting water jet panel 21 and three pieces of sensor block 31 are combined alternatively in X direction, which makes a row. And four rows of this combination are placed in Y direction, which comprises jet surface divided to sixteen areas.

Since jet surface of the cutting water jet system is comprised by combining cutting water jet panel 21 and sensor block 31 in the example shown in the figures, it is possible to jet high pressure water only to a certain cutting water jet panel in the designated area when sensor 30 detects the floating materials caught, by setting to the control circuit beforehand, the number and location of cutting water jet panel 21, which should be opened and shut electromagnetic valve 40 based on the detecting signal raised by each sensor block 31.

Although reflective type of sensor is used as sensor 30 in the example shown in the figures, other types of sensors, such as passage type sensor, can be easily used. For example, when passage type sensor is used, it is reasonable to install optional number of cutting water jet panel 21 between the sensor block which has emitting or signaling unit and the sensor block which has emit or signal receiving unit, and to secure required detecting distance, and both sensor blocks should be placed in the opposite position.

The upper surface area of the cutting water jet panel 21 and the number of the small holes 10 are determined optionally and the number and the combination structure of the cutting water jet panel 21 and the sensor block 31 are also optional. Furthermore since the number and the location of cutting water jet panel 21 controlled by the detecting signal of individual sensor block 21 can be decided previously, the content of control of the cutting water jet depends perfectly on free choice and decision of the person to practice.

Consequently in the cutting water jet system in the example shown in the figures, it is possible that various types of settings regarding the number and the location of the individual sensor block 31 and the cutting water jet panel 21 which is controlled based on the detecting signal of the sensor block, are memorized to the control circuit, and that different division area pattern of cutting water jet system is selected or switched depending to the number and the distribution of jellyfishes fed to the receiving tray.

On the example shown in the figures, the electromagnetic valve 40 is installed on the water supply branch pipe 23 connected to the cutting water jet panel 21, and the number of electromagnetic valves installed over the whole area of jet surface is adjusted by the area of the upper surface of the cutting water jet panel 21. The location of the electromagnetic valves can be selected freely on the supply line of cutting water to the cutting water jet panel 21, and it is possible to expand the area of the control unit division by the location of electromagnetic valve and to adjust the number of the electromagnetic valves over the whole area of the jet surface.

As shown in FIG. 6, the supply line of cutting water in the example is comprised with feed line 61 of the pump 60 which takes in seawater and pressurizes it, distribution line 62 corresponding to the row formed by the cutting water jet panel 21 and the sensor block 31, and the water supply branch pipe 23 connected to the cutting water jet panel 21. If the electromagnetic valve is not installed on the water supply branch pipe but only to the distribution pipe 62, for example, the row comprised with four cutting water jet panel 21 becomes the minimum division control unit (the number of sensor block 31 is optional), and the number of the electromagnetic valves over the whole jetting surface can be reduced to one fourth comparing to the original example.

However the longer the water supply distance between the location of the electromagnetic valve and the cutting water jet panel, the larger the time lag between the opening of the electromagnetic valve and the jet of the cutting water. Also the smaller the number of the electromagnetic valves, the more limited the control pattern of the cutting water jet.

Considering these points it is important to select the control pattern (cutting water jet pattern) to cut jellyfishes effectively. It is desirable to determine the number and the location of the electromagnetic valves over the whole jetting surface based on this control pattern and then to design the effective supply pipe line of cutting water.

For the explanation purpose, jetting surface of the cutting water jet system is physically divided to the cutting water jet panel 21 and the sensor block 31 in the example shown in the figures. However it is obvious that only some control division is necessary to be divided.

As mentioned above the cutting water jet system can select and realize various effective control measure to jet cutting water only when the floating materials caught exist on the receiving tray and only to the division part where the floating materials caught exist by combining the area of the cutting water jet panel, the number of the small holes, the combination of the cutting water jet panel and the sensor block, and the number and the location of the installed electromagnetic valves.

### BRIEF EXPLANATION OF FIGURES

FIG. 1: Brief flat view showing the realized structure of this invention

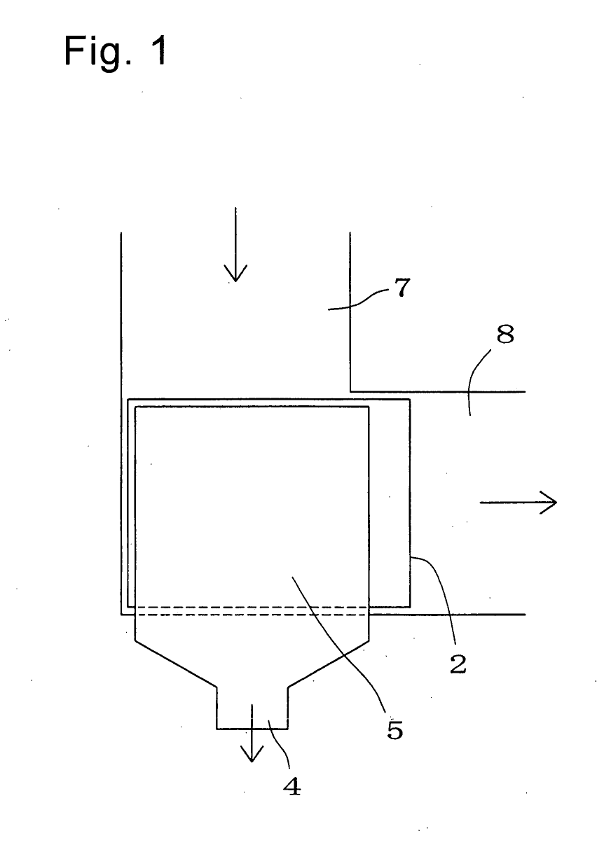

FIG. 2: Side view of the same

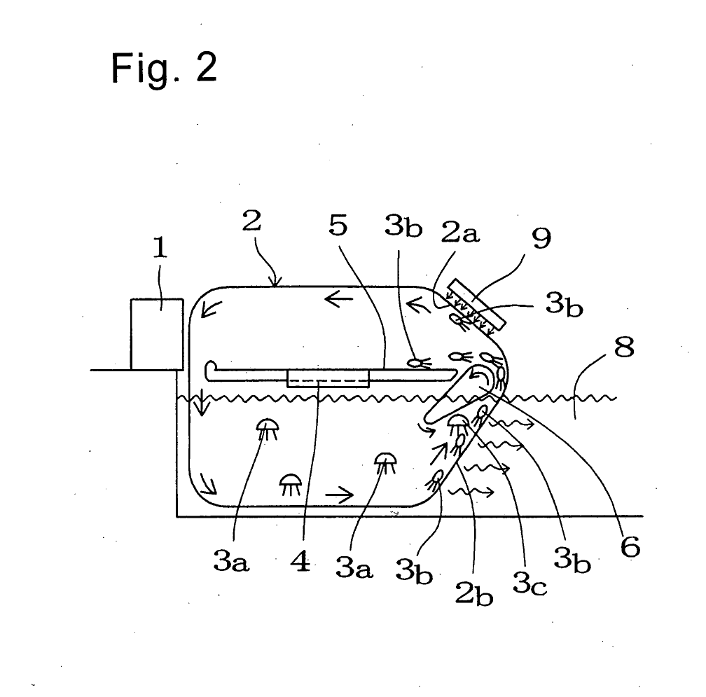

FIG. 3: Conceptual figure showing main portion of the receiving tray

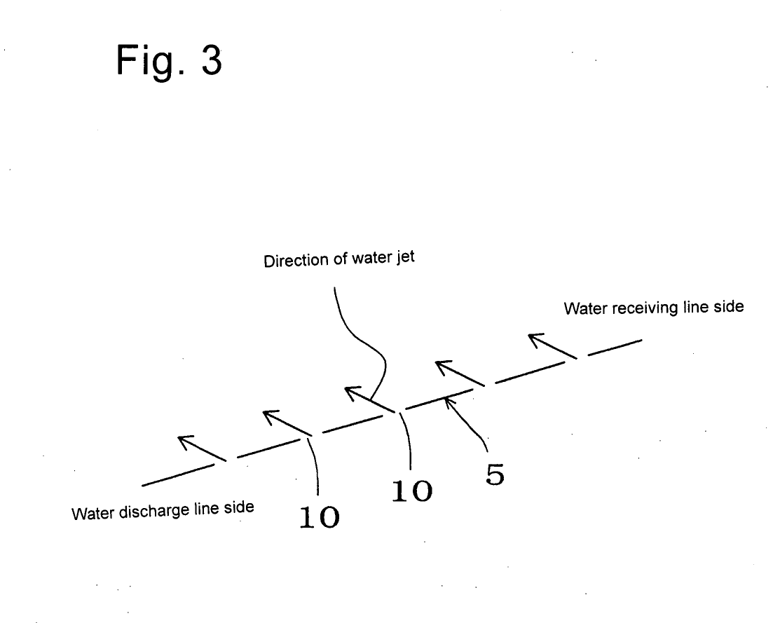

FIG. 4: Front view showing an example of control measure to the cutting water jet system

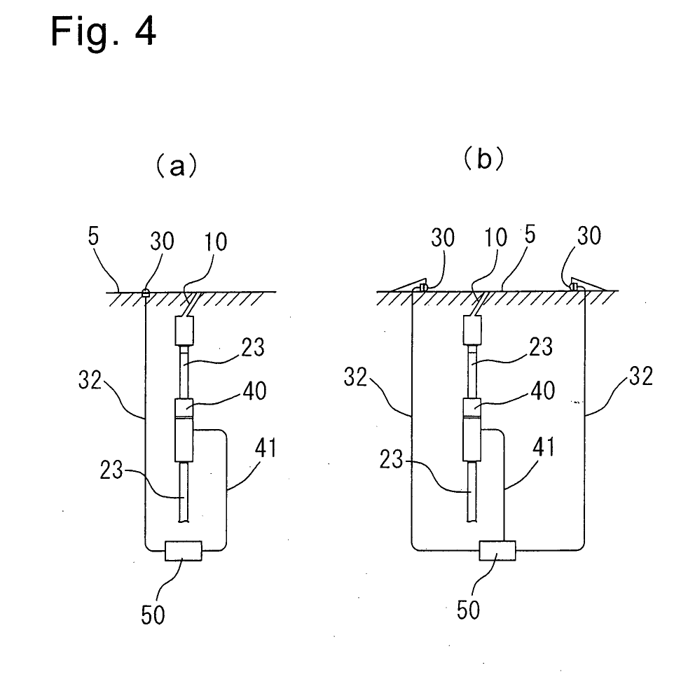

FIG. 5: Solid view partly cut showing an example of components of the cutting water jet system

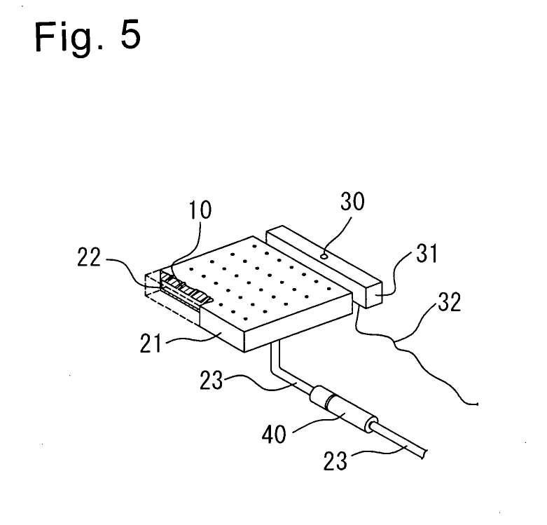

FIG. 6: Solid view showing an example of composition of the cutting water jet system

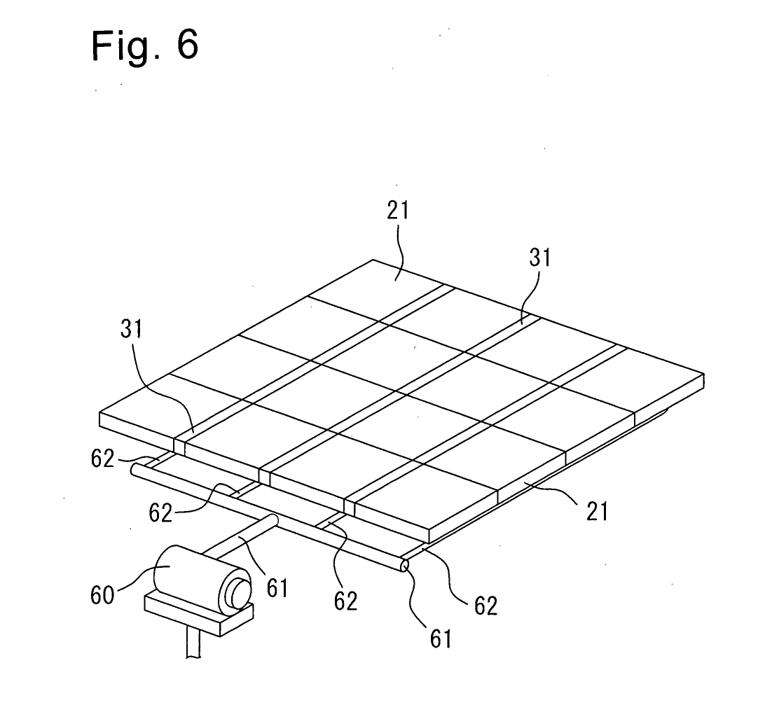

### EXPLANATION OF SYMBOL NUMBERS

1: Operation board
2: Main rotating removal screen
2a: upper portion
3a: Floating material in seawater
3b: Floating material caught
3c: Floating material in the neighborhood of water surface
4: Discharge line
5: Receiving tray
6: Secondary lifting devise
7: Water drawing line
8: Water intake line
9: Water jet system
10: Small hole
21: Cutting water jet panel
22: Water receiving part
23: Water supply branch pipe
30: Sensor
31: Sensor block
32: Sensor cable
40: Electromagnetic valve
41: Electric cable
50: Control circuit
60: Pump
61: Water supply pipe
62: Distribution pipe

1. Floating materials removal system that is characteristic in having the main rotating removal screen, which catches the floating materials such as big jellyfishes, wood chips, waste plastics and other things floating in water and transfers the floating materials caught to the higher position than water surface, and the receiving tray, which receives the floating materials caught by the main rotating removal screen and sends them to the discharge line.

2. Floating materials removal system mentioned in claim 1, that is characteristic in having the secondary lifting devise which cooperates with the above mentioned main rotating removal screen to lift the floating materials caught and to transfer them on the receiving tray.

3. Floating materials removal system mentioned in claim 1, that is characteristic in having the water jet system which drops the floating materials caught by the main rotating removal screen, but hooked to it, not released from it and lifted up to the higher position than the receiving tray, on the receiving tray.

4. Floating materials removal system, mentioned in claim 1, that is characteristic in having the cutting water jet system on the receiving tray to cut the floating materials caught.

5. Floating materials removal system mentioned in claim 4, of which cutting water jet system mentioned above, is characteristic in having the control system to control jet and stop of the cutting water.

6. Floating materials removal system mentioned in claim 5, that is characteristic in having the control system where jet surface of the above mentioned cutting water jet system is divided to various divisions, and the control unit of this control system is designed to one or some number of divisions above, and the cutting water jet is controlled to jet or stop based on this control unit.

7. Floating materials removal system mentioned in claim 5, that is characteristic in having the control system which has the sensor to detect the above mentioned floating materials caught, the electromagnetic valve installed in the water supply line to supply the cutting water to the above mentioned cutting water jet system, and the control circuit to electrically open the above mentioned electromagnetic valve based on the detecting signal of the above mentioned sensor and to shut the above mentioned electromagnetic valve by the elapse of the predetermined time period or by the disappearance of the detecting signal of the above mentioned sensor.
